(19) United States
(12) Patent Application Publication
(10) Pub. No.: US 2021/0267242 A1
(43) Pub. Date: Sep. 2, 2021

(54) SNOWPOWDER, GRANULAR COMPOSITION COMPRISING SUGAR ALCOHOL AND METHOD FOR PREPARING THE SAME

(71) Applicant: AMOREPACIFIC CORPORATION, Seoul (KR)

(72) Inventors: Sukyung Kim, Yongin-si (KR); Juyeon Seo, Yongin-si (KR); Jinoh Chung, Yongin-si (KR); Wanki Kim, Yongin-si (KR); Chan Woong Park, Yongin-si (KR); Jaehyun Kim, Yongin-si (KR); Hyoseung Lee, Yongin-si (KR)

(73) Assignee: AMOREPACIFIC CORPORATION, Seoul (KR)

(21) Appl. No.: 17/165,277

(22) Filed: Feb. 2, 2021

(30) Foreign Application Priority Data
Feb. 28, 2020 (KR) 10-2020-0025402
Oct. 19, 2020 (KR) 10-2020-0135541
Oct. 23, 2020 (KR) 10-2020-0138341

(51) Int. Cl. A23L 27/30; A23L 33/22; A23L 33/135; A23L 33/125; A23L 29/00

(52) U.S. Cl. CPC A23L 27/34; A23L 33/22; A23P 10/22; A23L 33/125; A23L 29/035; A23L 33/135

(57) ABSTRACT

One aspect of the present disclosure relates to a granular composition containing sugar alcohols and a method for preparing the same. More specifically, according to one aspect of the present disclosure, a granular composition having a particle size of 12 mesh to 60 mesh may be prepared by introducing raw materials containing a high content of sugar alcohols containing (i) xylitol and (ii) erythritol, mannitol or a combination thereof to an extrusion molding granular, and the granular composition has a softly melting texture and has an excellent effect in user's preference and convenience in ingestion.

### CROSS-REFERENCE TO RELATED APPLICATIONS

This application claims under 35 U.S.C. § 119(a) the benefit of Korean Patent Application No. 10-2020-0025402 filed on Feb. 28, 2020, Korean Patent Application No. 10-2020-0135541 filed on Oct. 19, 2020, and Korean Patent Application No. 10-2020-0138341 filed on Oct. 23, 2020 the entire contents of which are incorporated herein by reference.

### BACKGROUND

### (a) Technical Field

One aspect of the present disclosure relates to a granular composition comprising sugar alcohols and a method for preparing the same.

### (b) Background Art

Health functional foods have been released in various types of formulations, such as tablets, capsules, granules, and drinks in consideration of the convenience in ingestion and portability.

Among formulations of the health functional foods, granules are highly preferred in terms of texture. However, if the size of the granules is small, the preference of consumers may be lowered due to throat clogging or blowing of powder.

The sugar alcohol is a derivative of a monosaccharide, in which a carbonyl group (═CO) of a sugar is made into a hydroxyl group (—OH) by contact reduction of sugar. Since the sugar alcohol is not used in the body, the sugar alcohol has been widely used as a raw material and a product material used not only as a functional food such as a low-calorie sweetener, but also as a dietary food for a specific disease (obesity, and diabetes).

In addition, since the sugar alcohol has a high refreshing sensation and good melting properties in the mouth, preference for a composition containing the sugar alcohol is high. Therefore, attempts to develop a technology for applying the sugar alcohol in a high content as possible even when forming granules are continuing.

In the food field, granules are formed using a fluidized bed granulation process or an extrusion-molded granulation technology.

The fluidized bed granulation process is a technology that generates fine granules by spraying purified water or a concentrate having the same composition as a powder into the powder by a top-spray method while introducing and fluidizing the powder as a seed into a fluidized bed device. In the case of using the fluidized bed granulation process, granules containing a high content of sugar alcohols may be prepared, but since the size of the prepared granules is small, there is a problem in throat clogging or blowing of powder when ingested, and it is difficult to increase the content of sticky and good soluble raw materials like sugar.

The extrusion-molded granulation technology refers to a method in which raw materials are put into a container and extruded and molded from small holes by applying strong pressure. The extrusion-molded granulation technology has low processing cost and high production efficiency compared to the fluidized bed granulation process, but has a disadvantage in that it is difficult to elaborately prepare granules in a certain form and there is a limitation in selection of raw materials. In addition, since most of the extrusion-molded granules are made of heat-resistant substances such as starch as a main ingredient, the extrusion-molded granules have poor preference such as unpleasant taste and sticking between teeth when ingested. In the case of preparing granules containing a high content of sugar alcohols by the extrusion-molded granulation technology, a large amount of moisture needs to be added during granulation to enlarge the granules. In this case, since the sugar alcohol ingredient is melted and crystallized by frictional heat during extrusion molding, the sugar alcohol ingredient has a hard texture, and when less moisture is added, there is a difficulty in that granules are not formed.

In Japanese Patent Registration No. 2874778, there is disclosed a method for preparing crystalline globules by spray-drying an aqueous solution containing sugar alcohols such as sorbitol and mannitol. However, when granules are prepared by spray-drying the sugar alcohols, it is difficult to prepare the average particle size to a certain size or more, and as a result, when ingested, deterioration of preference such as blowing of powder or throat clogging may occur.

Accordingly, in consideration of consumer's preference, there is a demand for a technology for preparing granules having appropriate sizes without using starch and containing a high content of sugar alcohols.

Therefore, there is a need for a method for solving these problems.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In order to solve the problems, the present inventors intend to provide a granular composition having a size with high preference when ingesting granules by introducing a raw material containing a high content of sugar alcohols into an extrusion-molded granulation process.

Accordingly, an object of one aspect of the present disclosure is to provide a granular composition having a size with excellent preference when ingested and comprising a high content of sugar alcohols, and a method for preparing the same.

In order to achieve the object, one aspect of the present disclosure provides a granular composition comprising sugar alcohols containing (i) xylitol, and (ii) erythritol, mannitol or a combination thereof, wherein the sugar alcohols are included in an amount of 70 wt % to 99 wt % based on the total weight of the granular composition, and wherein the content of xylitol is larger than the total content of erythritol, mannitol or a combination thereof. In an embodiment, the sugar alcohol does not include sorbitol.

Another aspect of the present disclosure provides a granular composition having a particle size of 12 mesh to 60 mesh and comprising (i) xylitol, and (ii) erythritol, mannitol or a combination thereof, wherein the sugar alcohols are included in an amount of 70 wt % to 99 wt % based on the total weight of the granular composition, and wherein the content of (i) xylitol is larger than that of (ii) erythritol, mannitol or a combination thereof.

The other aspect of the present disclosure provides a method for preparing a granular composition comprising: (a) mixing (a-1) sugar alcohols containing (i) xylitol, and (ii) erythritol, mannitol or a combination thereof and (a-2) a binding solution; and

(b) forming granules by introducing the mixture obtained in step (a) into an extrusion molding granulator,

wherein the sugar alcohols are included in an amount of 70 wt % to 90 wt % based on the total weight of the granular composition, and wherein the content of (i) xylitol is larger than that of (ii) erythritol, mannitol or a combination thereof.

According to one aspect of the present disclosure, it is possible to prepare a granular composition having a size of 12 to 16 mesh with good preference when ingested without a starch base to be used generally to prepare stable granules in an extrusion molding process by introducing a raw material containing a high content of sugar alcohols into an extrusion-molded granulation process.

Since the granular composition contains xylitol, and erythritol, mannitol or a combination thereof as sugar alcohols in an appropriate amount, the granular composition is not crystallized even by frictional heat due to a frictional force generated in the extrusion-molded granulation process, and thus, the granule quality is excellent. In addition, since the granular composition has high strength due to the appropriate content of sugar alcohols, the granular composition is not easily crushed and the size of the granules is maintained for a long time, and thus, the reliability of the quality is excellent.

In addition, since the granular composition does not contain a starch base at all, there is no unpleasant taste unique in starch. Further, since a large amount of xylitol is contained even in the sugar alcohol, the granular composition has a softly melting texture in the mouth, and thus, a refreshing sensation is excellent.

The effects of one aspect of the present disclosure are not limited to the aforementioned effect, and other effects not mentioned above will be clearly understood to those skilled in the art from the description of the appended claims.

### DETAILED DESCRIPTION

Hereinafter, the present invention will be described in more detail.

The term “extrusion molding granulator” used in one aspect of the present disclosure is a general granulation device used to prepare granules in the art, and refers to a device for preparing granules by a preparation process of forming granules by centrifugal and frictional forces generated by passing raw materials through an appropriate screen network. As a type of the extrusion molding granulator, there is a reverse rotating granulator, and the shape of the granulator body may be a cylindrical shape or a shape widened upward.

Granular Composition Containing Sugar Alcohols

One aspect of the present disclosure relates to a granular composition comprising sugar alcohols containing (i) xylitol, and (ii) erythritol, mannitol or a combination thereof, wherein the sugar alcohols are included in an amount of 70 wt % to 90 wt % based on the total weight of the granular composition, and wherein the content of xylitol is larger than the content of erythritol, mannitol or a combination thereof. In an aspect, the sugar alcohol does not include sorbitol.

Another aspect of the present disclosure also relates to a granular composition having a particle size of 12 mesh to 60 mesh and comprising (i) xylitol, and (ii) erythritol, mannitol or a combination thereof, wherein the sugar alcohols are included in an amount of 70 wt % to 90 wt % based on the total weight of the granular composition, and wherein the content of (i) xylitol is larger than that of (ii) erythritol, mannitol or a combination thereof.

The sugar alcohol is a derivative of a monosaccharide, in which a carbonyl group (═CO) of a sugar is made into a hydroxyl group (—OH) by contact reduction of sugar. Since the sugar alcohol is not used in the body, the sugar alcohol has been widely used as a raw material and a product material used not only as a functional food such as a low-calorie sweetener, but also as a dietary food for a specific disease (obesity, and diabetes).

In one aspect of the present disclosure, the sugar alcohols are contained in a high content in the granular composition, and whether or not granules are formed, strength, quality, and texture may be adjusted due to a combination of the sugar alcohols and a content ratio thereof.

The sugar alcohols may include a first sugar alcohol and a second sugar alcohol, wherein the first sugar alcohol xylitol and the second sugar alcohol is erythritol, mannitol or a combination thereof, and these sugar alcohols have a property weaker to frictional heat than starch, but when an appropriate moisture condition is applied, the frictional heat may be minimized and granules may be produced.

The sugar alcohols may be included in an amount of 70 wt % to 99 wt % based on the total weight of the granular composition. Specifically, the content of sugar alcohols may be 70 wt % or more, 80 wt % or more, 90 wt % or more, and 99 wt % or less, 98 wt % or less, and 97 wt % or less. If the content of sugar alcohols is less than 70 wt %, the properties of the mixture may be affected by raw materials other than the sugar alcohols to make it difficult to prepare granules, or the emotional quality of the prepared granules may be deteriorated due to frictional heat during the extrusion-molded granulation process. When the sugar alcohols are more than 99 wt %, the content of tea tree leaf dietary fiber is relatively reduced, and thus, a health functional effect of the tea tree leaf dietary fiber may be reduced when ingesting the granular composition.

In addition, in a weight ratio of (i) xylitol and (ii) erythritol, mannitol or a combination thereof contained in the sugar alcohols, the weight ratio of (i) xylitol may be relatively larger than that of (ii) erythritol, mannitol or a combination thereof. If the weight ratio of (i) xylitol is relatively smaller than or equal to that of (ii) erythritol, mannitol or a combination thereof, the xylitol may be crystallized and become hard during the extrusion-molded granulation process, resulting in deterioration of the granule quality. In addition, since the strength of the prepared granules is weak, the granules are powdered, and as a result, when ingested, there may be a phenomenon of blowing of the powder or throat clogging.

Specifically, the weight ratio of the (i) xylitol and (ii) erythritol, mannitol or a combination thereof may be 1:0.7 to 1:0.96. Specifically, when the weight of the (i) xylitol is 1, the weight ratio of (ii) erythritol, mannitol or a combination thereof may be 0.7 or more, 0.8 or more, 0.84 or more, 0.96 or less, 0.94 or less, and 0.92 or less. When the xylitol is more included according to the range of the weight ratio, the strength is excellent, and thus, the granules with excellent quality may be prepared without forming powder.

In the present disclosure, the granular composition may further include one or more selected from the group consisting of dietary fiber, lactic acid bacteria, citric acid, lactose, and fragrance.

The one or more selected from the group consisting of dietary fiber, lactic acid bacteria, citric acid, lactose, and fragrance may be included in an amount of 0.1 wt % to 5 wt %, specifically 0.1 wt % or more, 0.2 wt % or more, or 0.3 wt % or more, or 1 wt % or less, 3 wt % or less, or 5 wt % or less, based on the total weight of the granular composition.

In one aspect of the present disclosure, the dietary fiber is a lot of ingredient contained in vegetables, fruits, and seaweeds among foods, and is a polymetric carbohydrate that is not digested by human digestive enzymes and is discharged from the body. Due to the property of this dietary fiber, when the dietary fiber is sufficiently ingested, the dietary fiber gives a feeling of fullness while suppressing digestion and absorption, and thus, the dietary fiber is known to have functions of preventing overeating, making a bowel movement smooth, discharging harmful substances such as cholesterol and heavy metals, affecting the bacteria in the intestines to suppress harmful bacteria, and helping in the proliferation of beneficial bacteria as prebiotics.

When the dietary fiber is included in the amount of 0.1 wt % to 5 wt % in the granular composition as described above, the efficacy as dietary fiber (smooth bowel movement and prebiotics) is good, and thus, the effectiveness as a raw material of the health functional food is most excellent and taste preferences may also be good.

The dietary fiber may include at least one of insoluble dietary fiber and water-soluble dietary fiber. The insoluble dietary fiber and the water-soluble dietary fiber may be classified according to solubility in water.

In the present disclosure, the insoluble dietary fiber is dietary fiber having an insoluble property in water by forming a very strong fibrous structure after long glucose chains of cellulose agglomerate so close to each other in a straight line, and is mainly much included in cereals and vegetables. The insoluble dietary fiber increases the volume of stool to prevent constipation, and is excellent in intestinal function such as increasing fecal volume and improving diarrhea.

The insoluble dietary fiber may include one or more selected from the group consisting of dietary fiber of tea leaf, crystalline cellulose, lignin, chitin, dietary fiber of wheat, dietary fiber of oat, and hemicellulose. In the insoluble dietary fiber, the dietary fiber of tea leaf may be used in consideration of compatibility with sugar alcohol or consumer preference, etc.

In one aspect of the present disclosure, the tea tree leaf dietary fiber has a potential as prebiotics that may help to proliferate beneficial bacteria and inhibit harmful bacteria in the intestine like general dietary fiber.

In addition, in one aspect of the present disclosure, the tea tree leaf dietary fiber has a potential as prebiotics that may make a bowel movement smooth and help to proliferate beneficial bacteria and inhibit harmful bacteria in the intestine like general dietary fiber.

In addition, in one aspect of the present disclosure, the tea tree leaf dietary fiber may refer to dietary fiber isolated from the tea tree leaves. Alternatively, the tea tree leaf dietary fiber may refer to dietary fiber isolated from the tea tree and the tea tree leaves.

In addition, the tea tree leaf dietary fiber according to one aspect of the present disclosure is obtained from tea tree leaves and may be obtained by removing catechins, proteins, caffeine, and other impurities contained in the tea tree leaves by a process of extracting tea tree or tea tree leaves.

Further, the tea tree leaf dietary fiber may be included in an amount of 0.1 wt % to 5 wt % based on the total weight of the granular composition. Specifically, the content of the tea tree leaf dietary fiber may be 0.1 wt % or more, 0.2 wt % or more, 0.3 wt % or more, and 5 wt % or less, 4 wt % or less, 3 wt % or less, 2 wt % or less, and 1 wt % or less. If the content of the tea tree leaves is less than 0.1 wt %, the efficacy as dietary fiber (bowel movement and prebiotics) may decrease, and thus, the effectiveness as a raw material of the health functional food may decrease. If the content of the tea tree leaf dietary fiber is more than 5 wt %, emotional quality may be deteriorated due to the bitter and astringent taste unique to the tea tree leaf powder.

In addition, the water-soluble dietary fiber refers to an oligosaccharide having a relatively small molecular weight and a water-soluble property, and is dietary fiber having a well-soluble property in water, and is mainly much included in fruits. The water-soluble dietary fiber has excellent effects such as proliferation of useful bacteria in the intestine, improvement of lipid metabolism, etc.

The water-soluble dietary fiber may include one or more selected from the group consisting of polydextrose, glucomannan, β-glucan, pectin, chicory extract powder, indigestible maltodextrin, inulin, psyllium husk powder, fucoidan, guar gum, gellan gum, and alginic acid.

In addition, the lactic acid bacteria belong to probiotics, and are known to have a beneficial effect on intestinal health when ingested, and are thus much used as food additives.

The lactic acid bacteria is not particularly limited as long as the lactic acid bacteria may be used as an additive in food, but for example, the lactic acid bacteria may be one or more selected from the group consisting of Streptococcus genus, Lactococcus genus, Enterococcus genus, Lactobacillus genus, Pediococcus genus, Leukonostoc genus, Weissella genus, Bifidobacterium genus and Bacillus genus.

When the lactic acid bacteria are included in an amount of 0.1 wt % to 5 wt % in the granular composition as described above, an effect of promoting intestinal health such as proliferation of lactic acid bacteria, inhibition of harmful bacteria, or promotion of bowel movement may be most excellent.

In addition, the citric acid is generally used as a sweetener in food, and citric acid is generally used. The citric acid is a weak organic acid and may be obtained from citrus, lemon, etc.

When the citric acid is included in an amount of 0.1 wt % to 5 wt % in the granular composition as described above, the taste preference of the granular composition may be most excellent.

In addition, the lactose is also generally used as a sweetener in food, and refers to a disaccharide form of sugar consisting of glucose and galactose.

When the lactose is included in an amount of 0.1 wt % to 5 wt % in the granular composition as described above, the taste preference of the granular composition may be most excellent.

In addition, the fragrance is an additive for improving the fragrance of food and is not particularly limited as long as the fragrance may be applied to food. The fragrance may be applied in the form of powder, liquids, etc.

When the fragrance is included in an amount of 0.1 wt % to 5 wt % in the granular composition as described above, the taste preference of the granular composition may be most excellent.

In another aspect of the present disclosure, the particle size of the granular composition may be 12 mesh or more, 14 mesh or more, and 16 mesh or more. The particle size range may mean a case in which 80% or more of granules that pass through 12 mesh and do not pass through 60 mesh are contained. In addition, the particle size of the granular composition may be 60 mesh or less, 50 mesh or less, 40 mesh or less, and 30 mesh or less. In other words, the particle size of the granular composition may be a size remaining between 12 to 16 mesh, and the granules passing through 60 mesh may have a small size to form powder, which may result in blowing of the powder or throat clogging when ingested. If the granular composition does not pass through 12 mesh, it may be difficult to implement a softly melting texture. The unit “mesh” representing the particle size of the granular composition is a standard unit for classifying the particle size of a powdery substance, and means the number of meshes between 1 inch (24.5 mm), and may mean that the larger the mesh value, the smaller the particles size.

The granular composition of one aspect of the present disclosure may further include one or more selected from the group consisting of an excipient, a binder, a disintegrant, a fragrance, a sweetener, a coloring agent, and a preservative commonly used in food compositions. At this time, the sweetener refers to a sweetener that may be additionally used in addition to the sugar alcohol according to one aspect of the present disclosure.

The excipient is not particularly limited in one aspect of the present disclosure as long as the excipient is a substance added to easily ingest the formulation or to make a certain form. Examples of the excipient may include maltodextrin, calcium carbonate, sucrose, lactose, glucose, mannitol, isomalt, xylitol, gelatin, (micro)crystalline cellulose, sorbitol, maltitol, hypromellose (HPMC), sodium lauryl sulfate, sodium alginate, calcium phosphate, and the like, but are not limited thereto.

The binder is a substance that allows the form of the formulation to be maintained, and may be, for example, one or more selected from water, ethanol, a hydroxypropylcellulose suspension, a hydroxypropylmethylcellulose suspension, and an ethylcellulose aqueous suspension.

The disintegrant is a substance for promoting disintegration in the digestive tract in the body, and may be, for example, one or more selected from hydroxypropyl methylcellulose, bentonite, sodium carboxymethylcellulose, calcium carboxymethylcellulose, sodium alginate, sodium lauryl sulfate, silicic anhydride, 1-hydroxypropyl cellulose, dextran, ion exchange resin, polyvinyl acetate, formaldehyde-treated casein and gelatin, alginic acid, amylose, guar gum, sodium bicarbonate polyvinylpyrrolidone, arabic rubber, amylopectin, pectin, sodium polyphosphate, ethylcellulose, white sugar, and magnesium aluminum silicate.

The sweetener serves to shield bitter taste, and may use, for example, white sugar, glucose, D-sorbitol, aspartame, licorice extract, erythritol, steviol glycoside, enzyme-treated stevioside, and the like.

The fragrance may use, for example, orange oil, fruit juice, cinnamon oil, spearmint oil, peppermint, vanilla, peppermint oil, rose oil, lemon oil, berry flavor, strawberry flavor, grape flavor, berry flavor, yogurt flavor, and the like.

The coloring agent may use, for example, artificial coloring agents such as edible synthetic pigments; natural coloring agents such as gardenia yellow, safflower yellow, cochineal extract, caramel, monascus color, and saffron; and the like.

As the preservative, for example, dehydroacetic acids, sorbic acids, benzoic acids, propionic acids, paraoxybenzoic acid esters, and the like may be used.

In addition, the granular composition of one aspect of the present disclosure may further include additives such as a stabilizer, a thickener, an extender, or a pH adjuster commonly used in food compositions.

The granular composition according to one aspect of the present disclosure may be applied to various health functional foods.

Preparation Method of Granular Composition Containing Sugar Alcohols

The other aspect of the present disclosure also relates to a method for preparing a granular composition containing sugar alcohols, and the method for preparing the granular composition includes (a) mixing sugar alcohols containing (i) xylitol, and (ii) erythritol, mannitol or a combination thereof; and a binding solution; and (b) forming granules by introducing the mixture obtained in step (a) to an extrusion molding granulator, wherein the sugar alcohols are included in an amount of 70 wt % to 90 wt % based on the total weight of the granular composition, and wherein the content of (i) xylitol is larger than that of (ii) erythritol, mannitol or a combination thereof. In addition, after step (b), the method may further include (c) drying and sizing the granules obtained in step (b).

Hereinafter, the present invention will be described in more detail for each step.

In the other aspect of the present disclosure, in step (a), the sugar alcohols containing (i) xylitol and (ii) erythritol, mannitol or a combination thereof; and the binding solution may be mixed to form the mixture. In addition, the tea tree leaf dietary fiber may be further mixed to form the mixture. At this time, the weights of the sugar alcohols and the tea tree leaf dietary fiber are as described above.

The binding solution may be appropriately mixed with the sugar alcohols so that the extrusion molding process in step (b) may be performed more smoothly. The binding solution may be selected from water and ethanol. The mixing amount of the binding solution is not particularly limited, but may be 0.5 wt % or more, 10 wt % or less, 8 wt % or less, and 5 wt % or less based on the total weight of the mixture obtained in step (a).

In addition, the additives as described above may be mixed together.

The mixing may be performed using a general mixer used in the art to mix raw materials.

In step (b), the mixture obtained in step (a) may be introduced into an extrusion molding granulator to prepare the granular composition.

The extrusion-molded granulation method is an apparatus for forming granules by an extrusion-molded granulation process in which the mixture passes through a screen network having small holes with a predetermined size, and the granules may be formed by the centrifugal force and frictional force generated during the extrusion molding.

In addition, after step (b), the method may further include (c) drying and sizing the granules obtained in step (b).

Through the sizing process, the particle size of the granules may be made uniform, and the strength of the granular composition may be increased through drying and the reliability of the quality may be improved.

In addition, the tea tree leaf dietary fiber, the insoluble dietary fiber among the dietary fibers, may be prepared by the following steps (1) to (5):

(1) first extracting tea tree leaves with ethanol and second extracting the remaining residue with purified water;

(2) extracting the remaining tea tree leaf residue with alkali after the first and second extraction in step (1);

(3) solid-liquid separating the alkali extract and the extract residue obtained in step (2) to remove the alkali extract and then adding and neutralizing an acid to the remaining extraction residue;

(4) solid-liquid separating the extracted residue neutralized in step (3) to remove the added acid and then washing the remaining extraction residue; and

(5) drying and pulverizing the solid extract obtained after step (4) to prepare dietary fiber.

In step (1), after the tea tree leaves are first extracted with ethanol, the remaining tea tree leaf residue may be second extracted with purified water.

The first extraction may be a process of removing catechin from the tea tree leaves. At this time, the ethanol may be 50% or more.

In addition, the temperature at the time of the first extraction may be 30° C. or more, 40° C. or more, 50° C. or more, 65° C. or more, 80° C. or less, and 75° C. or less, and the time may be 0.5 hour or more, 4 hours or less, and 2 hours or less. The temperature and time at the time of the first extraction are optimal temperature and time capable of removing catechin from the tea tree leaves, and in the case of less than the above range, the catechin may not be removed as desired, and in the case of more than the above range, the active ingredients included in the tea tree leaves may be denatured. In addition, in addition to the catechin, chlorophyll, caffeine, and other impurities may also be removed together.

The second extraction may be a process of removing a water-soluble substance from the first extracted tea tree leaves. In this case, the water-soluble substance may mean water-soluble dietary fiber and sugars.

In addition, the temperature at the time of the second extraction may be 80° C. or more, 85° C. or more, 100° C. or less, and 95° C. or less, and the time may be 2 hours or more, 2.5 hour or more, 4 hours or less, and 3.5 hours or less. The temperature and time at the time of the second extraction are optimal temperature and time capable of removing only the water-soluble substance from the first extracted tea tree leaves, and in the case of less than the above range, the water-soluble substance may not be removed as desired, and in the case of more than the above range, the active ingredients included in the tea tree leaves may be denatured.

In this way, after the first extraction and the second extraction, the catechin and the water-soluble substance may be sequentially removed from the tea tree leaves to obtain the tea tree leaf residue.

In step (2), the remaining tea tree leaf residue may be extracted with alkali after the first and second extraction in step (1).

In this case, the alkali used in the extraction using the alkali may be one or more selected from the group consisting of sodium hydroxide, potassium hydroxide, magnesium hydroxide, magnesium oxide, calcium oxide, and sodium hydrogen carbonate. Preferably, the alkali may be a 0.2 M to 5 M aqueous alkali solution in consideration of the selective removal efficiency of proteins contained in the tea tree leaf residue.

In addition, the temperature and time at the time of the extraction using the alkali may be 70° C. or more, 80° C. or more, 100° C. or less, and 90° C. or less, and may be 1 hours or more, 1.5 hour or more, 3 hours or less, and 2.5 hours or less. The temperature and time at the time of the extraction using the alkali are optimal temperature and time capable of selectively removing only the proteins from the tea tree leaf residue, and in the case of less than the above range, the proteins may not be removed as desired, and in the case of more than the above range, the active ingredients included in the tea tree leaves may be denatured.

In step (3), the alkali extract obtained in step (2) may be solid-liquid separated to remove the alkali extract, and then an acid may be added and neutralized to the remaining alkali extraction residue.

The alkali extraction residue may be washed and then neutralized with water.

The neutralization may be performed to pH 6 to 8 by adding an acid to the alkali extract. The acid may be one or more selected from the group consisting of acetic acid, L-glutamic acid, lactic acid, hydrochloric acid, malic acid, succinic acid, citric acid, ethylenediamine-N, N, N′, N′-tetraacetic acid (EDTA: edetic acid), EDTA2Na, EDTA3Na, and EDTA4Na, and preferably acetic acid. In addition, the acid may be 0.1 to 1 M of an aqueous acid solution in consideration of the efficient neutralization of the alkali extract.

In step (4), the extracted residue neutralized in step (3) may be solid-liquid separated to remove the added acid during neutralization and then the remaining extraction residue may be washed. At this time, the removed solution may be an acid solution used during neutralization, and may be washed with water.

In step (5), the solid extract obtained after step (4) may be dried and pulverized to prepare the dietary fiber.

Hereinafter, preferred Examples of the present invention will be provided to help in understanding of the present invention. However, the following Examples are just illustrative of the present invention, and it will be apparent to those skilled in the art that various changes and modifications can be made within the scope and the technical idea of the present invention and that these variations and modifications are within the scope of the appended claims.

### Example 1

According to a composition as shown in Table 1 below, a granular composition was prepared in the following method.

In a mixer (high shear mix, Nara Corporation), xylitol and mannitol, which were sugar alcohols, were added and mixed to obtain a mixture. At this time, purified water was added together as a binding solution and mixed.

The mixture was introduced into an extrusion molding granulator (Dalton Co., Ltd.) to form granules, and then introduced into a sizer (SEOWON ENG Inc.) to uniformly size the granules, and then dried at room temperature for 30 minutes to prepare a granular composition.

TABLE 1

| | | Example | Example | Example | Example | Example | Comparative | Comparative | Comparative |
|---|---|---|---|---|---|---|---|---|---|
| (Unit: Wt %) | | 1 | 2 | 3 | 4 | 5 | Example 1 | Example 2 | Example 3 |
| Sugar | Xylitol | 50 | 50 | 50 | 50 | 50 | 0 | 0 | 40 |
| alcohol | Mannitol | 45 | 45 | 0 | 45 | 45 | 95 | 45 | 55 |
| | Erythritol | 0 | 0 | 45 | 0 | 0 | 0 | 0 | 0 |

| | | | | | | | | |
|---|---|---|---|---|---|---|---|---|
| Tea tree leaf | 0 | 0.5 | 0.5 | 0 | 0 | 0.5 | 0 | 0.5 |
| dietary fiber | | | | | | | | |
| Lactic acid | 0 | 0 | 0 | 0.5 | 0 | 0 | 0 | 0 |
| bacteria | | | | | | | | |
| Citric acid | 0 | 0 | 0 | 0 | 0.5 | 0 | 0 | 0 |
| Starch | 0 | 0 | 0 | 0 | 0 | 0 | 50 | 0 |
| Purified water | 4 | 4 | 4 | 4 | 4 | 4 | 4 | 4 |
| Fragrance | To 100 | To 100 | To 100 | To 100 | To 100 | To 100 | To 100 | To 100 |

### Example 2

A granular composition was prepared in the same manner as in Example 1, except that tea tree leaf dietary fiber was further mixed with sugar alcohols.

The tea tree leaf dietary fiber was prepared by the following method.

100 g of tea tree leaves were first extracted for 2 hours at 50° C. using 1500 g of 50% ethanol, and then second extracted at 90° C. for 3 hours using 1500 g of purified water.

After the first and second extraction, 70 g of the remaining tea tree leaf residue (excluding moisture contained) was immersed and extracted in 1050 g of a 0.5 M sodium hydroxide aqueous solution at 90° C. for 2 hours, and solid-liquid separated to obtain an alkali extraction residue.

The remaining alkali extract in the alkali extraction residue was washed with drinking water to remove residual alkali. Then, 500 g of a 0.2 M aqueous acetic acid solution was added and neutralized to 50 g of the obtained solid alkali extraction residue.

After the extract was removed by solid-liquid separating the neutralized extract, the remaining solid extraction residue was washed with drinking water to remove a residual acid.

Thereafter, the solid extract was dried and pulverized to prepare the tea tree leaf dietary fiber.

### Example 3

A granular composition was prepared in the same manner as in Example 2, except for using xylitol and erythritol instead of xylitol and mannitol as sugar alcohols.

### Example 4

A granular composition was prepared in the same manner as in Example 2, except for using lactic acid bacteria (Lactobacillus plantarum APsulloc 331261, accession number: KCCM11179P) instead of the tea tree leaf dietary fiber.

At this time, the lactic acid bacteria were used through the following treating process.

The lactic acid bacteria were cultured for 24 hours after subculture on an MRS agar plate of −80° C. stock. A cultured single colony was inoculated into an MRS broth and cultured for 24 hours. 100 μl of the cultured colonies were again inoculated into the MRS broth and cultured for 48 hours. Then, the colonies were subjected to cell down at 5000 rpm for 5 minutes and washed three times with tertiary distilled water. The lactic acid bacteria were pulverized by sonication at a temperature of 4° C. for 2 hours to be used for preparing the granular composition.

### Example 5

A granular composition was prepared in the same manner as in Example 2, except for using citric acid instead of the tea tree leaf dietary fiber.

### Comparative Example 1

A granular composition was prepared in the same manner as in Example 1, except for using 95 wt % of mannitol instead of xylitol and 95 wt % of mannitol as sugar alcohols.

### Comparative Example 2

A granular composition was prepared in the same manner as in Example 1, except for using 45 wt % of mannitol instead of xylitol and 95 wt % of mannitol as sugar alcohols, not using tea tree leaf dietary fiber, and using 50 wt % of starch.

### Comparative Example 3

A granular composition was prepared in the same manner as in Example 1, except for using 40 wt % of xylitol and 55 wt % of mannitol instead of 45 wt % of xylitol and 50 wt % of mannitol as sugar alcohols.

### Experimental Example 1

For the granular compositions prepared in Examples and Comparative Examples, the particle size of the granules, the quality of the granules, the strength of the granules, the emotional quality and the melting rate were measured by the following methods, and the results were shown in Table 2 below.

(1) Measurement of Particle Size of Granules

For the granular compositions prepared in Examples and Comparative Examples, the particle sizes were measured using a particle size analyzer (Malvern, Mastersizer 3000).

(2) Evaluation of Quality of Granules

For the granular compositions prepared in Examples and Comparative Examples, whether the granules were aggregated and crystallized was observed with the naked eye. It was evaluated that the more crystallized granules were observed, the poorer the quality of the granules were.

<Evaluation Criteria of Quality of Granules>

High: No crystallization of granules was observed

Medium: Crystallization was observed in some of the whole granules (less than 20% crystallization in the granules)

Low: Crystallization was observed in many of the whole granules (20% or more crystallization in the granules)

(3) Evaluation of Strength of Granules

The granular compositions prepared in Examples and Comparative Examples were dropped from the top of a 40 mesh sieve to evaluate the strength of the granules. The holes formed in the sieve were smaller than the granular composition, and the powder formed when the granular composition collided with the sieve passed through the sieve, and thus, it was evaluated that as the amount (weight of the powder passing through the sieve, %) of powder passing through the sieve relative to the weight of the dropped granular composition was increased, the strength was weaker.

<Evaluation Criteria of the Strength of Granules>

Strong: Less than 40% of the amount of powder passed through the sieve relative to the weight of the dropped granular composition

Medium: 40% to 80% of the amount of powder passed through the sieve relative to the weight of the dropped granular composition

Weak: More than 80% of the amount of powder passed through the sieve relative to the weight of the dropped granular composition

(4) Emotional Quality and Melting Rate

Evaluation of the emotional quality and the melting rate of the granular compositions prepared in Examples and Comparative Examples was conducted. The emotional quality was classified and evaluated into unpleasant taste and throat clogging.

Evaluation panels consisted of 20 adults aged 20 to 40 years old, and 1 g of each of the granular compositions prepared in Examples and Comparative Examples were directly ingested for the panels to evaluate unpleasant taste, throat clogging, and melting rate. The unpleasant taste and the throat clogging were evaluated using a 7-point scale method, and it is meant that as the lower a score, the smaller the unpleasant taste and the throat clogging. The melting rate refers to the time taken until completely dissolved after ingestion.

Table 2 below shows the evaluation results for the particle size of the granules, the quality of the granules, the strength of the granules, the emotional quality, and the melting rate for the results obtained in Examples and Comparative Examples.

TABLE 2

| | | Example | Example | Example | Example | Example | Comparative | Comparative | Comparative |
|---|---|---|---|---|---|---|---|---|---|
| | | 1 | 2 | 3 | 4 | 5 | Example 1 | Example 2 | Example 3 |
| Particle size | | 35 | 30 | 40 | 40 | 35 | 12 | 10 | 7 |
| of granules (mesh) | | | | | | | | | |
| Granule quality | | High | High | High | High | High | Low | High | Medium |
| Granule strength | | Strong | Strong | Strong | Strong | Strong | Weak | High | Weak |
| Emotional | Unpleasant | 0.8 | 0.7 | 1.1 | 1 | 1.2 | 2.8 | 6.1 | 1.1 |
| quality | taste | | | | | | | | |
| | Throat | 0.9 | 0.9 | 0.8 | 0.8 | 0.8 | 5.9 | 1.1 | 6.3 |
| | clogging | | | | | | | | |

| | | | | | | | | |
|---|---|---|---|---|---|---|---|---|
| Melting rate (min) | 0.9 | 0.83 | 1 | 1.1 | 0.8 | 3.1 | 2.8 | 1.2 |

As shown in Table 2, it can be seen that the granular compositions prepared in Example 1 to Example 5 were prepared in sizes between 12 mesh and 60 mesh, respectively, and the strength of the granules was excellent, so that the generation of powder was prevented and the throat clogging was small. In addition, since the granular compositions of Examples 1 to Example 5 were prepared by introducing raw materials containing a high content of sugar alcohols into the extrusion-molded granulation process, it was confirmed that the quality was good because the granules were not crystallized, and due to the high content of sugar alcohol, it was not unpleasant and the melting rate was fast, so that a refreshing texture could be exhibited.

The granular composition of Comparative Example 1 does not contain xylitol as sugar alcohols, but contains only mannitol, and is crystallized through the extrusion-molded granulation process to cause aggregation, and accordingly, it can be seen that the melting rate in the mouth is slowed, so that the softly melt texture is not shown. In addition, it was confirmed that the granular composition of Comparative Example 1 exhibited a throat clogging phenomenon because the strength was weak and the powder was easily generated.

The granular composition of Comparative Example 2 was a granular composition having a big particle size and containing starch and was not crystallized, so that the quality of the granules was good, and the strength was also good. However, the granular composition of Comparative Example 2 was evaluated as having a high degree of unpleasant taste due to starch, and it was confirmed that the melting rate was also slow.

The granular composition of Comparative Example 3 also has a big particle size and contains more mannitol than xylitol in xylitol and mannitol, which are sugar alcohols, and it was confirmed that some of the granules were crystallized to deteriorate the quality of the granules, and the strength of the granules was weak to generate a large amount of powder, and thus, the throat clogging occurred when ingested.

As described above, the prepared embodiment of the present invention has been described, and in addition to the embodiments described above, a fact that the present invention can be materialized in other specific forms without departing from the gist or scope thereof will be apparent to those skilled in the art. Therefore, the aforementioned embodiments are not limited but should be considered to be illustrative, and accordingly, the present invention is not limited to the aforementioned description and will be modified within the scope of the appended claims and a range equivalent thereto.

What is claimed is:

1. A granular composition comprising: sugar alcohols containing (i) xylitol, and (ii) erythritol, mannitol or a combination thereof,
wherein the sugar alcohols are included in an amount of 70 wt % to 90 wt % based on the total weight of the granular composition, and
wherein the content of (i) xylitol is larger than that of (ii) erythritol, mannitol or a combination thereof.

2. The granular composition of claim 1, wherein a weight ratio of the (i) xylitol and (ii) erythritol, mannitol or a combination thereof is 1:0.7 to 1:0.96.

3. The granular composition of claim 1, further comprising:
one or more selected from the group consisting of dietary fiber, lactic acid bacteria, citric acid, lactose, and fragrance.

4. The granular composition of claim 3, wherein the dietary fiber includes at least one of insoluble dietary fiber and water-soluble dietary fiber.

5. The granular composition of claim 4, wherein the insoluble dietary fiber contains tea tree leaf dietary fiber.

6. The granular composition of claim 3, wherein the content of the one or more selected from the group consisting of dietary fiber, lactic acid bacteria, citric acid, lactose and fragrance is 0.1 wt % to 5 wt % based on the total weight of the granular composition.

7. The granular composition of claim 1, wherein a particle size of the granular composition is 12 mesh to 60 mesh.

8. A granular composition having a particle size of 12 mesh to 60 mesh and comprising sugar alcohols containing (i) xylitol, and (ii) erythritol, mannitol or a combination thereof,
wherein the sugar alcohols are included in an amount of 70 wt % to 90 wt % based on the total weight of the granular composition, and
wherein the content of (i) xylitol is larger than that of (ii) erythritol, mannitol or a combination thereof.

9. A method for preparing a granular composition of claim 1 comprising:
(a) mixing sugar alcohols containing (i) xylitol, and (ii) erythritol, mannitol or a combination thereof and a binding solution; and
(b) forming granules by introducing the mixture obtained in step (a) into an extrusion molding granulator,
wherein the sugar alcohols are included in an amount of 70 wt % to 90 wt % based on the total weight of the granular composition, and
wherein the content of (i) xylitol is larger than that of (ii) erythritol, mannitol or a combination thereof.

10. The method for preparing the granular composition of claim 9, wherein in step (a), one or more selected from the group consisting of dietary fiber, lactic acid bacteria, citric acid, lactose and fragrance is further mixed.

11. The method for preparing the granular composition of claim 10, wherein the dietary fiber includes an insoluble dietary fiber, a water-soluble dietary fiber, or a combination thereof.

12. The method for preparing the granular composition of claim 11, wherein the insoluble dietary fiber contains tea tree leaf dietary fiber.

13. The method for preparing the granular composition of claim 12, wherein the tea tree leaf dietary fiber is prepared by the following steps (1) to (5):
(1) first extracting tea tree leaves with ethanol and second extracting the remaining residue with purified water;
(2) extracting the remaining tea tree leaf residue with alkali after the first and second extraction in step (1);
(3) solid-liquid separating the alkali extract and the extract residue obtained in step (2) to remove the alkali extract and then adding and neutralizing an acid to the remaining extraction residue;
(4) solid-liquid separating the extracted residue neutralized in step (3) to remove the added acid and then washing the remaining extraction residue; and
(5) drying and pulverizing the solid extract obtained after step (4) to prepare dietary fiber.
